(19) United States
(12) Patent Application Publication
(10) Pub. No.: US 2014/0148938 A1
(43) Pub. Date: May 29, 2014

(54) Object Profile for Object Machining

(71) Applicant: MICROSOFT CORPORATION, Redmond, WA (US)

(72) Inventors: Allen Dayong Zhang, Guangdong (CN); Massood Nikkhah, Kent, WA (US); Michael Joseph Lane, Bellevue, WA (US); Cao Zhiqiang, Shenzhen (CN); Andrew William Hill, Redmond, WA (US)

(73) Assignee: Microsoft Corporation, Redmond, WA (US)

(21) Appl. No.: 13/689,541

(22) Filed: Nov. 29, 2012

(51) Int. Cl. G06F 17/50

(52) U.S. Cl. CPC G06F 17/50
USPC 700/163

(57) ABSTRACT

Techniques for object profile for object machining are described. In at least some implementations, an object profile is generated by measuring attributes of an object, such as its dimensions. The object profile can correspond to a data representation of object attributes. The object profile is employed to determine a machining path for machining the object based on a particular design and/or pattern. In at least some implementations, an alignment guide is generated that enables an object to be positioned for machining by a machining device. The alignment guide, for instance, can correspond to a particular position in a coordinate space. Aligning an object with the alignment guide includes moving the object (e.g., rotationally and/or translationally) to align with the alignment guide. When aligned with the alignment guide, the object can be machined according to a specified object profile and/or pattern.

### RELATED MATTERS

This application claims priority under 35 USC 119(b) to International Application No. PCT/CN2012/083075 filed Oct. 17, 2012, the disclosure of which is incorporated in its entirety.

### BACKGROUND

Many products are manufactured according to a specified design or form factor. For instance, a mobile phone manufacturer can design a mobile phone to have a specific physical profile, such as based on aesthetic and/or ergonomic considerations. A number of different techniques are available for manufacturing a product based on a set of form specifications.

One such technique is injection molding, which forces a heated material into a mold to attain a particular shape with the material. Examples of materials that can be utilized for injection molding include plastics, resins, metals, and so on. While injection molding can be convenient in a manufacturing scenario, it is typically not suitable for products that have rigid dimensional tolerances and/or finish requirements.

Another such technique is milling, which employs various types of cutting and/or boring tools to shape material to a particular form. Typical milling techniques, however, are difficult to utilize for more complex forms and/or surfaces.

Thus, certain design scenarios can present a number of challenges to current manufacturing techniques.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for object profile for object machining are described. In at least some implementations, an object profile is generated by measuring attributes of an object, such as its dimensions. The object profile can correspond to a data representation of object attributes. The object profile is employed to determine a machining path for machining the object based on a particular design and/or pattern.

In at least some implementations, an alignment guide is generated that enables an object to be positioned for machining by a machining device. The alignment guide, for instance, can correspond to a particular position in a coordinate space. Aligning an object with the alignment guide includes moving the object (e.g., rotationally and/or translationally) to align with the alignment guide. When aligned with the alignment guide, the object can be machined according to a specified object profile and/or pattern.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ the techniques described herein in accordance with one or more embodiments.

FIG. 2 depicts an example implementation scenario of techniques discussed herein in accordance with one or more embodiments.

FIG. 3 depicts an example implementation scenario of techniques discussed herein in accordance with one or more embodiments.

FIG. 4 depicts an example implementation scenario of techniques discussed herein in accordance with one or more embodiments.

FIG. 5 illustrates a flow diagram that describes steps in a method in accordance with one or more embodiments.

FIG. 6 depicts an example implementation scenario of techniques discussed herein in accordance with one or more embodiments.

FIG. 7 depicts an example implementation scenario of techniques discussed herein in accordance with one or more embodiments.

FIG. 8 illustrates a flow diagram that describes steps in a method in accordance with one or more embodiments.

FIG. 9 illustrates an example system including various components of an example device that can be implemented as any type of computing device as described with reference to FIG. 1 to implement embodiments of the techniques described herein.

### DETAILED DESCRIPTION

Overview

Techniques for object profile for object machining are described. In at least some implementations, an object profile is generated by measuring attributes of an object, such as its dimensions. The object profile can correspond to a data representation of object attributes. The object profile is employed to determine a machining path for machining the object based on a particular design and/or pattern.

In at least some implementations, an alignment guide is generated that enables an object to be positioned for machining by a machining device. The alignment guide, for instance, can correspond to a particular position in a coordinate space. Aligning an object with the alignment guide includes moving the object (e.g., rotationally and/or translationally) to align with the alignment guide. When aligned with the alignment guide, the object can be machined according to a specified object profile and/or pattern.

In the following discussion, a section entitled “Example Environment” discusses an example environment that may employ techniques described herein. Embodiments discussed herein are not limited to the example environment, and the example environment is not limited to embodiments discussed herein. Next, a section entitled “Example Implementation Scenarios” discusses some example implementation scenarios in accordance with one or more embodiments. Following this, a section entitled “Corner Machining” describes example implementations for machining object corners in accordance with one or more embodiments. Finally, an example system and device are discussed that may implement various techniques described herein.

Example Environment

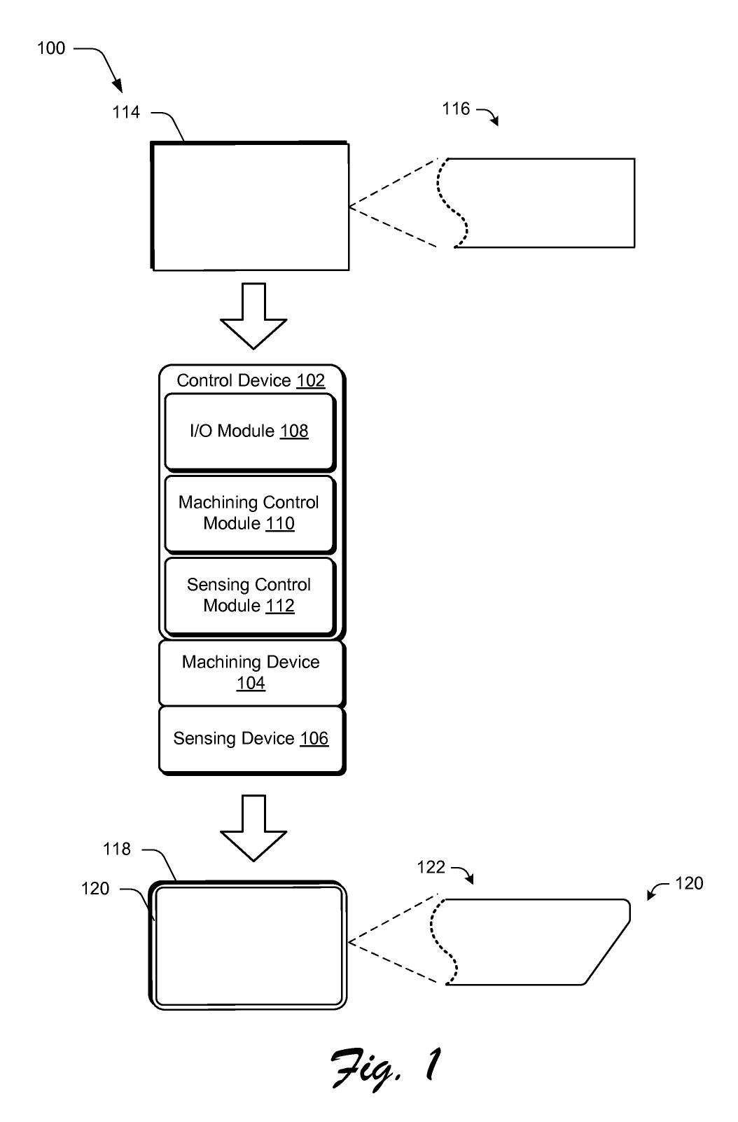

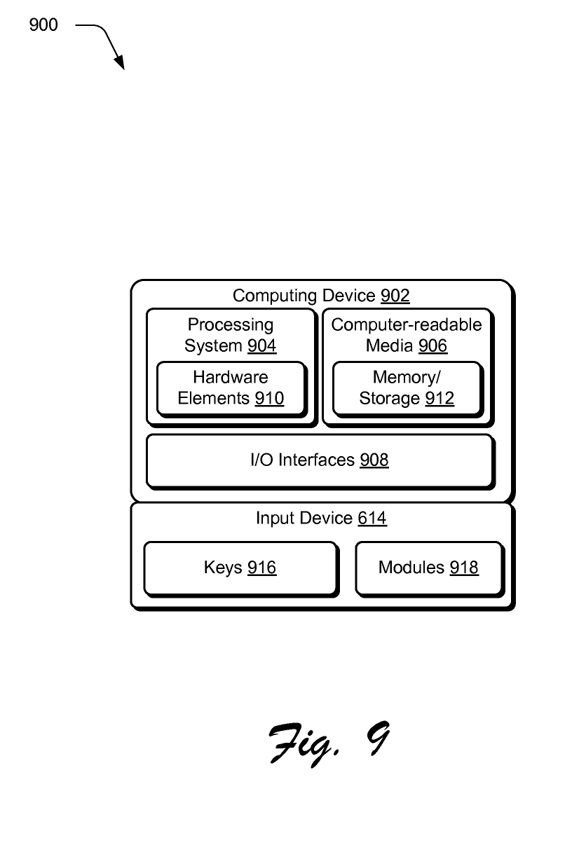

FIG. 1 is an illustration of an environment 100 in an example implementation that is operable to employ the techniques described herein. The environment 100 includes a control device 102, which can be configured as a computing device that is capable of performing various operations. One example implementation of the control device 102 is discussed below with reference to FIG. 9.

The control device 102 includes and/or is operably associated with a machining device 104, which is configured to remove material from portions of an object according to techniques discussed herein. For instance, the machining device 104 can include types of tools for removal of material from an object, such as tools for boring, cutting, etching, milling, grinding, and so on. A variety of other machining mechanisms and/or techniques may be employed within the spirit and scope of the claimed embodiments.

Although not expressly illustrated here, the machining device 104 can include and/or be operably associated with a motive device, such as a motor, a servo, or other suitable mechanism to enable movement of the machining device 104. For instance, the machining device 104 can be movable to remove material from an object according to a specified pattern, coordinates, and so on.

The control device 102 further includes and/or is further operably associated with a sensing device 106, which is representative of functionality to detect various physical attributes of an object according to techniques discussed herein. For instance, the sensing device 106 can be configured to measure dimensions of an object, such as an object's length, width, thickness, and so on. The sensing device 106 may employ any suitable detecting mechanism and/or combination of mechanisms, such as a contact probe, a laser, an image capture device (e.g., a camera), sonic and/or ultrasonic measurement, and so on. Example implementations of the sensing device 106 are discussed below.

An input/output (I/O) module 108 and a machining control module 110 are further included. The I/O module 108 is configured to receive various types of input, such as input from a user, another device, a data storage medium, and so on. In at least some implementations, input to the I/O module 108 can include specifications for machining an object to a particular profile. For instance, the specifications can include machining coordinates (e.g., in a geometric coordinate system) that specify regions and/or portions of an object that are to be machined to match a profile.

The machining control module 110 represents functionality to control various operations of the machining device 104. In at least some implementations, the machining control module 110 can represent a driver that provides an interface to the machining device 104 from the I/O module 108. For instance, the machining control module 110 can control movement of the machining device 104 according to specified machining coordinates and/or machining pattern for a particular object.

A sensing control module 112 is further included, which represents functionality to control operation of the sensing device 106. For instance, the sensing control module 112 can represent a driver that provides an interface to the sensing device 106 from the I/O module 108. In at least some implementations, the sensing control module 112 can control motion of the sensing device 106 to enable the sensing device 106 to scan an object and detect various attributes of the object.

The sensing control module 112 can receive input from the sensing device 106, such as detected attributes of an object, and can provide the input to other portions of the control device 102. For instance, the sensing control module 112 can provide detected object attributes to the machining control module 110, which can utilize the object attributes to control operation of the machining device 104 in accordance with various embodiments discussed herein.

The control device 102 is generally associated with a known 3-dimensional coordinate space which the control device 102 may employ to perform various techniques discussed herein. For instance, the machining device 104 and/or the sensing device 106 may be manipulated to particular positions within the known 3-dimensional coordinate space.

The environment 100 further includes an object 114, which is representative of an instance of various physical objects which can be machined according to techniques discussed herein. The object 114, for instance, can be configured as an instance of a wide variety of different objects, such as a computing device (e.g., a mobile computing device), a toy, a medical device, and/or any other object that includes a surface that can be machined. Further illustrated is a side view 116 of a partial cross-section of the object 114.

Further to the environment 100, the object 114 is processed by the control device 102 to produce a machined object 118. The machined object 118 includes a machined edge 120 that is applied to the object 114 according to techniques discussed herein.

For instance, the sensing device 106 detects dimensions of the object 114, such as its length, width, and thickness. The dimensions are passed to the machining control module 110 (e.g., by the sensing control module 112), which utilizes the dimensions to control operation of the machining device 104 to remove material from the edge of the object 114. Removal of the material creates the machined edge 120 on the machined object 118.

Further illustrated is a partial side view 122 that illustrates a side view of the machined edge 120. The example machining of the object 114 to produce the machined object 118 is illustrated for purpose of example only, and techniques discussed herein may be employed to machine a wide variety of different objects and according to a wide variety of different machining patterns.

Example Implementation Scenarios

This section discusses some example implementations scenarios in accordance with various embodiments.

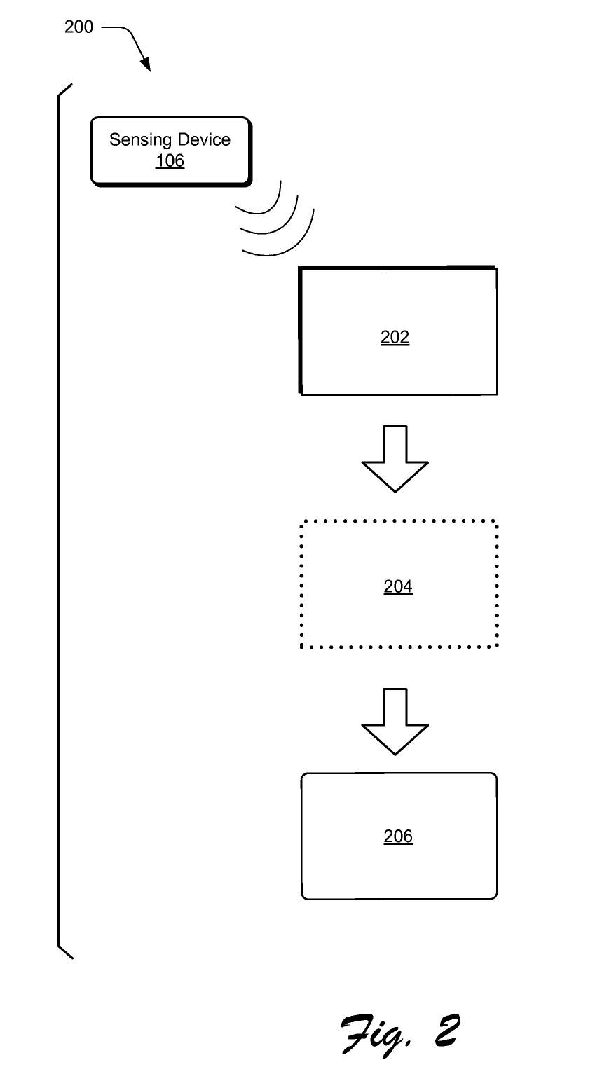

FIG. 2 illustrates an example implementation scenario 200 according to techniques described herein. In the upper portion of the scenario 200, the sensing device 106 detects dimensions of an object 202, such as its length, width, thickness, and so forth. The object 202, for instance, can be formed from various types of materials, such as plastic, metal and/or metal alloy, resin, natural material, and so forth. In at least some implementations, the object 202 can be formed via an industrial process, such as injection molding, die cutting, and so on.

As referenced above, the sensing device 106 can employ a variety of different techniques for detect attributes of the object 202. In at least some implementations, the sensing device 106 can utilize a contact probe that contacts the surface of the object 202, and moves around the surface to detect its dimensions and/or other surface characteristics. For instance, the sensing device 106 can detect positions of points on the surface of the object 202 relative to a reference coordinate space utilized by the sensing device 106.

Another technique that can be employed by the sensing device 106 is laser scanning, which can detect dimensions of the object 202. These are but two examples, and a variety of other sensing techniques may be employed in accordance with the claimed embodiments.

Continuing to the center portion of the scenario 200, an object profile 204 is generated for the object 202 based on the detected dimensions. The object profile 204 is representative of data that describes dimensions and/or other physical attributes of the object 202. For instance, the object profile 204 can include data points that describe the relative position of the peripheral surface of the object 202 in a coordinate space. In this particular example, the object profile 204 describes the dimensions and relative positions of the outer edge of the object 202, e.g., the physical outline of the object 202.

Continuing to the lower portion of the scenario 200, a machining path 206 is generated based on the object profile 204. In at least some implementations, the machining path 206 specifies a machining path for the machining device 104 to follow when machining material from the object 202. In this particular example, the machining path 206 specifies a machining path for the machining device 104 to apply an edge pattern to the object 202.

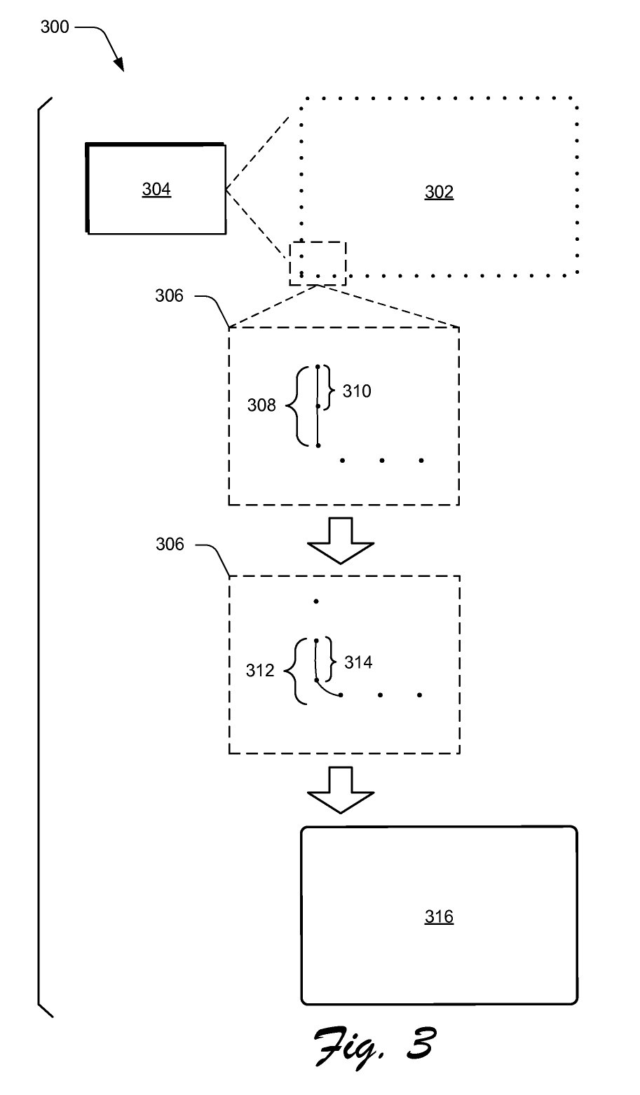

FIG. 3 illustrates an example implementation scenario 300 according to techniques described herein. The scenario 300 describes an example way of determining a machining path for an object, as introduced above.

In the upper portion of the scenario 300, an object profile 302 for an object 304 is illustrated. As discussed above, the object profile 302 can be generated based on detected attributes of the object 304, such as its dimensions and/or relative positions of points on its surface. In this particular example, the object profile 302 includes data points that each correspond to positions on an outer surface of the object 304.

Further to the scenario 300, to determine a machining path for machining the object 304, the data points of the object profile 302 are connected. For instance, continuing with the scenario 300, a portion 306 of the object profile 302 is illustrated. In the portion 306, a group of data points is connected by generating an arc 308 using the data points. A half 310 of the arc 308 is selected to generate a corresponding portion of an ablation path.

Continuing with the scenario 300, a different group of data points from the portion 306 is connected by generating an arc 312 using the data points. Further to this example, notice that the different group of data points includes some data points from the previous point group. A half 314 of the arc 312 is selected to generate a corresponding portion of a machining path. For instance, the half 314 is connected to the half 310 to form a portion of a machining path.

Continuing to the lower portion of the scenario 300, a similar process as discussed above is performed for the remaining data points of the object profile 302 to form a machining path 316. For instance, arcs are generated between sets of consecutive data points (e.g., every 3 data points), and portions of the arcs are selected to form portions of the machining path 316. The machining path 316 can be employed as a guide path for guiding a machining device (e.g., the machining device 104) to machine portions of the object 304. For instance, the machining path 316 can correspond to physical spatial coordinates relative to the object 304. A machining device can be moved along the machining path 316 relative to the object 304 to machine (e.g., ablate) portions of the object 304.

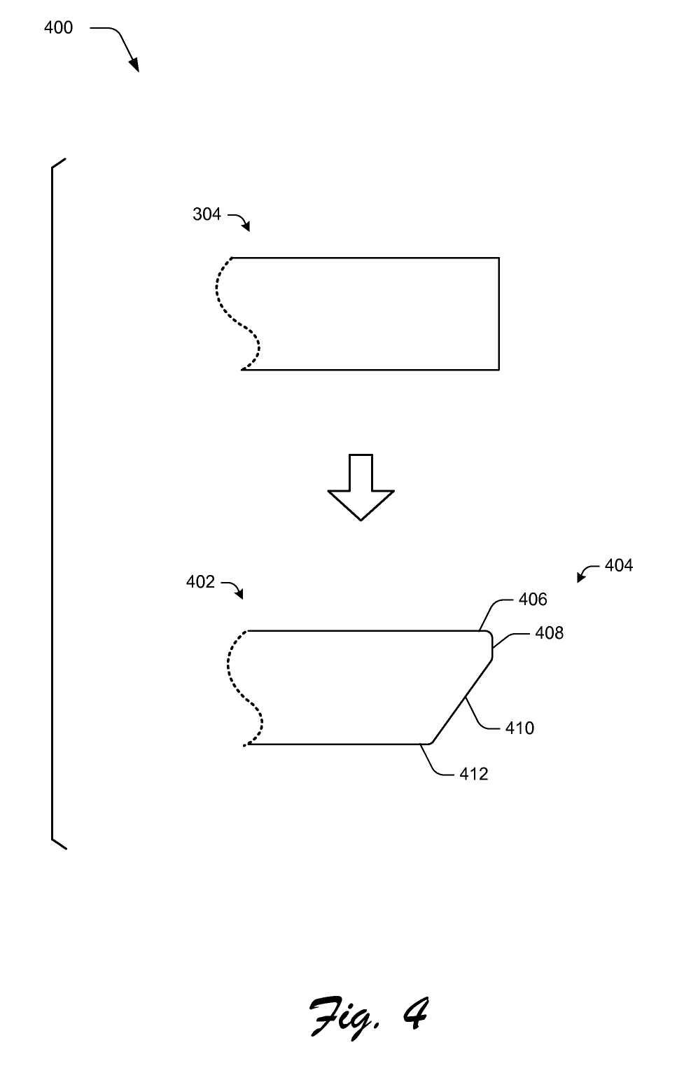

FIG. 4 illustrates an example implementation scenario 400 according to techniques described herein. In at least some implementations, the scenario 400 details aspects of machining the object 304 according to the machining path 316, discussed above. In the upper portion of the scenario 400, a side view of a partial cross-section of the object 304 is illustrated.

Continuing to the lower portion of the scenario 400, the object 304 is machined according to techniques discussed herein to produce a machined object 402, e.g., via the control device 102 and associated functionalities. The machined object 402 includes a machined edge 404, which includes a top surface 406, a first edge surface 408, a second edge surface 410, and a bottom surface 412. As illustrated, the machined edge 404 is such that the first edge surface 408 and the second edge surface 410 are located on a peripheral edge of the machined object 402 and are non-coplanar.

According to various embodiments, the machined edge 404 is applied to the machined object 402 by moving the machining device 104 around the object 304 according to the machining path 316, discussed above. The machining device 104, for instance, can include a cutting tool which is configured to remove material from edges of the object 402 according to a pre-specified design pattern, as indicated by the profile of the machined edge 404. For instance, the top surface 406, the first edge surface 408, and the second edge surface 410 can be machined into the machined object 402 by the machining device 104 in a single pass around the edge of the object 304 to produce the machined edge 404. Thus, in at least some embodiments, techniques discussed herein can be employed to machine multiple edge surfaces in a single machining pass.

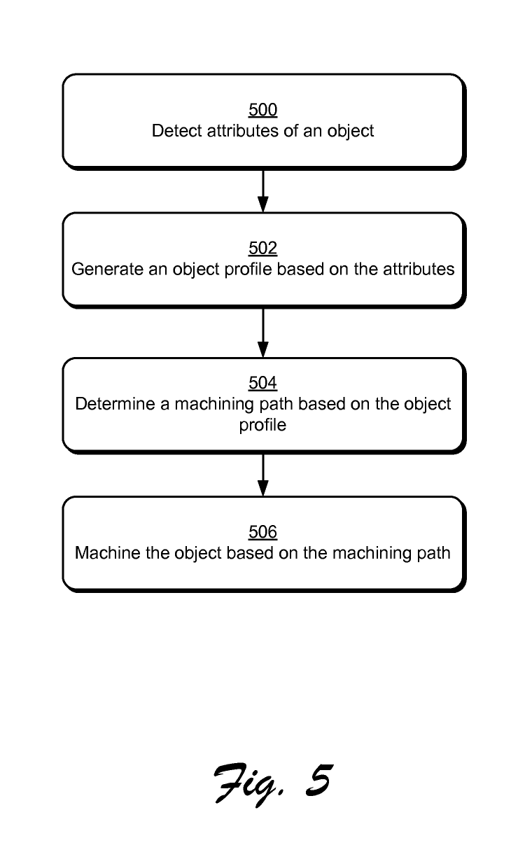

FIG. 5 is a flow diagram that describes steps in a method in accordance with one or more embodiments. Step 500 detects attributes of an object. For instance, dimensions of an object can be measured, such as height, width, thickness, corner angles, and so on. Example ways of measuring device attributes are discussed above.

Step 502 generates an object profile based on the attributes. For instance, data points can be generated that correspond to portions of an objects surface. The data points can be connected in various ways to generate a data representation of a physical profile of the object. Example ways of generating an object profile are discussed above.

Step 504 determines a machining path based on the object profile. For instance, the machining path can correspond to spatial coordinates defined by the object profile. Alternatively or additionally, the object profile can be manipulated in various ways to determine the machining path. For instance, the object profile can be reduced in size by a particular percentage to produce the machining path.

In at least some implementations, the machining path can be based on a predetermined machining pattern that can be adjusted based on the object profile. The predetermining machining pattern can be generated (e.g., via user input) to correspond to particular features, such as surface features to be machined into an object. Further, the predetermined machining pattern can be specified to be machined at a particular region of an object, such as at a particular offset distance from an edge of the object. To enable the object to be machined based on the predetermined machining pattern, an object profile can be generated that indicates certain object dimensions. The predetermined machining pattern can be adjusted (e.g., positionally and/or dimensionally) to fit the object dimensions such that the predetermined machining pattern is applied at a particular region of the object when the object is machined. A machining path can be generated as discussed above to enable the predetermined machining pattern to be applied the particular region when the object is machined.

Step 506 machines the object based on the machining path. For instance, a machining tool (e.g., the machining device 104) can be applied to an object according to the machining path to remove material from the object. As referenced above, material can be removed from an object according to a particular pattern, such as to achieve a machined edge and/or other surface on the object.

Corner Machining

In various implementations, corners of an object can be machined to obtain a specific corner profile. For instance, the corners of a tablet computing device chassis can be machined to conform the tablet to a particular device profile. This section discusses some example implementations scenarios for machining object corners in accordance with various embodiments.

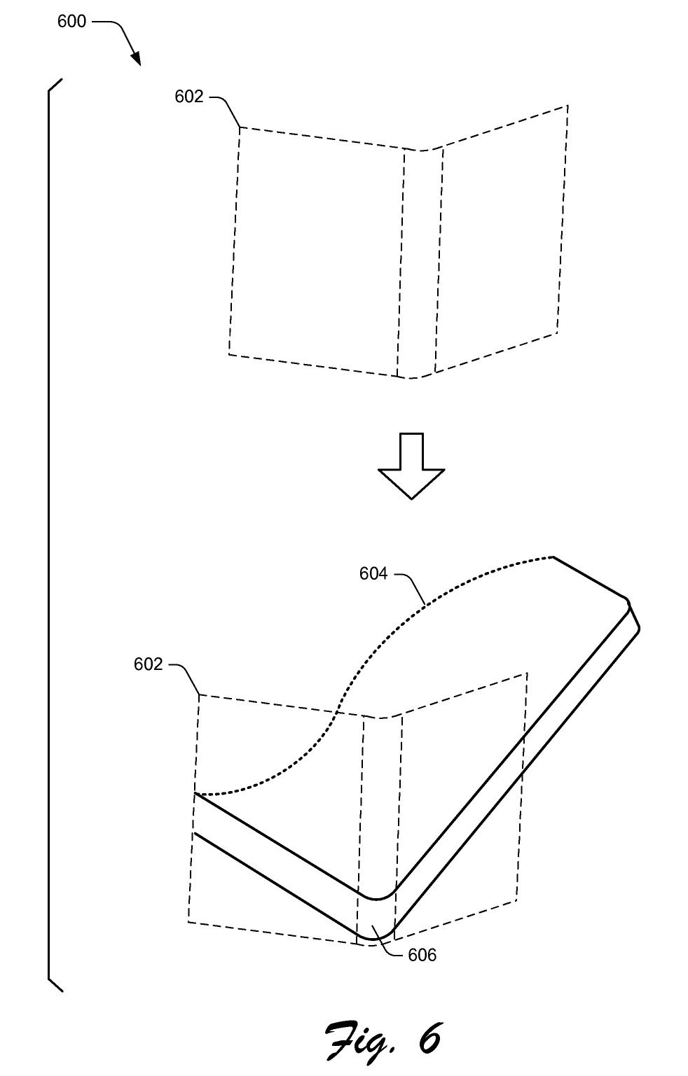

FIG. 6 illustrates an example implementation scenario 600, in accordance with one or more embodiments. The scenario 600 illustrates an alignment guide 602, which is a data representation of an alignment guide for aligning an object to be machined. For instance, the alignment guide 602 can be representative of a curved 2-dimensional plane that has a specific location in a 3-dimensional coordinate space. With reference to the control device 102, for example, the alignment guide 602 can correspond to a known set of coordinates that the control device 102 can utilize to guide the machining device 104.

Continuing to the lower portion of the scenario 600, an object 604 is aligned with the alignment guide 602. For instance, the object 604 can be physically manipulated (e.g., rotated and/or translated by the control device 102) such that a corner 606 of the object 604 is aligned with the alignment guide 602. Alignment of the object 604 corresponds to a placement of the object at particular location in a 3-dimensional coordinate space, such as at a known location and angular orientation. Further, alignment of the object 604 can be accomplished by detecting a location and/or orientation of the object 604, such as via the sensing device 106. Thus, the object 604 can be aligned with the alignment guide 602 by manipulating the object 604 such that the corner 606 and surrounding edges of the object 604 overlap with the alignment guide 602.

In accordance with various embodiments, the alignment guide 602 is associated with a particular machining path for a machining device. For instance, a machining device can follow a particular machining route relative to the alignment guide 602. In at least some implementations, the alignment guide can correspond directly to a machining route. Alignment of the object 604 with the alignment guide 602 can thus enable the corner 606 and/or other portions of the object 604 to be machined according to a particular (e.g., pre-specified) profile and/or pattern. Other corners and/or regions of the object 604 may be aligned with the alignment guide 602 to enable similar machining of different portions of the object 604.

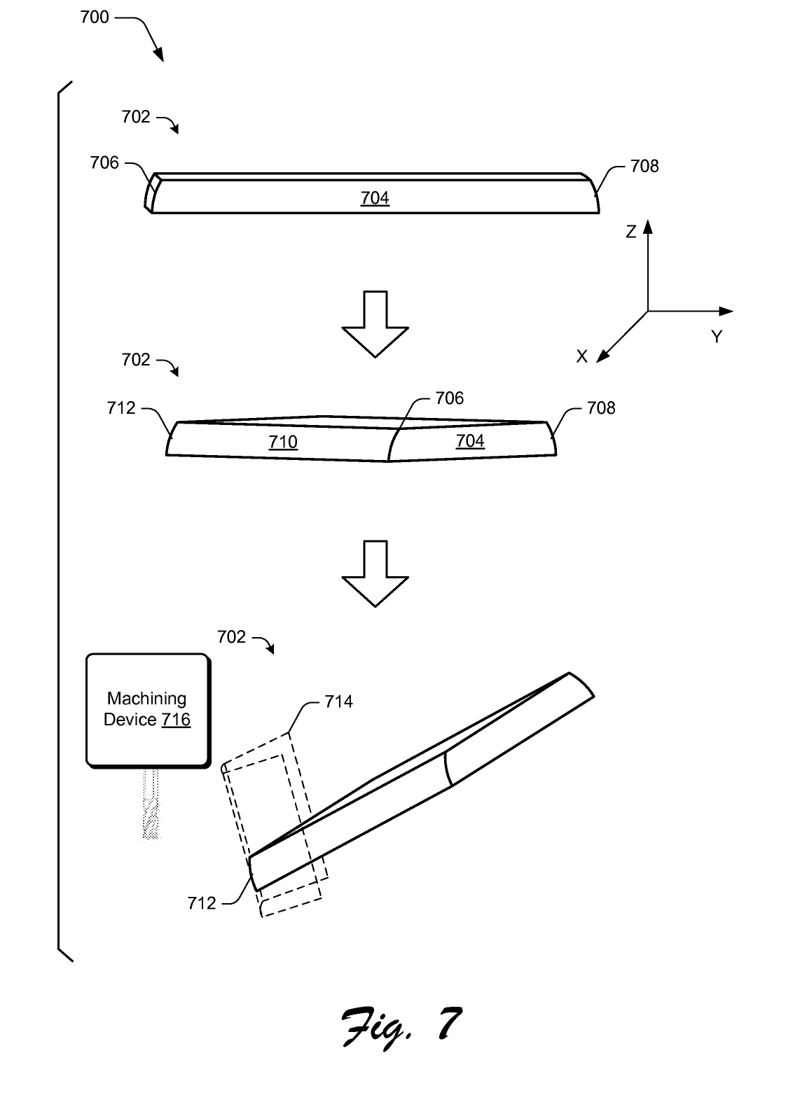

FIG. 7 illustrates an example implementation scenario 700, in accordance with one or more embodiments. The scenario 700 illustrates an example implementation for aligning an object for machining, such as discussed above.

The upper portion of the scenario 700 includes an object 702, which is viewed from a side angle. The object 700 includes a side 704, a corner 706, and a corner 708. While not expressly illustrated here, the object 702 can be mounted to a mechanism that enables the object 702 to be manipulated in various directions and orientations. For instance, the control device 102 discussed above can include a servo and/or other mechanism, that can enable physical manipulation of the object 702.

Continuing to the center portion of the scenario 700, the object 702 is rotated such that a side 710 and a corner 712 are visible. For instance, the object 702 is rotated at a particular degree of rotation (e.g., 45 degrees) about a Z-axis.

Continuing to the lower portion of the scenario 700, the object 702 is rotated to align the object with an alignment guide 714. For instance, the object 702 is rotated about an X-axis at a particular degree of rotation, e.g., 35 degrees. Alignment with the alignment guide 714 aligns the corner 712 with a machining path for a machining device 716 to enable the corner 712 and/or other portions to be machined to a particular profile and/or pattern. The machining device 716 can be implemented as an embodiment of the machining device 104, discussed above.

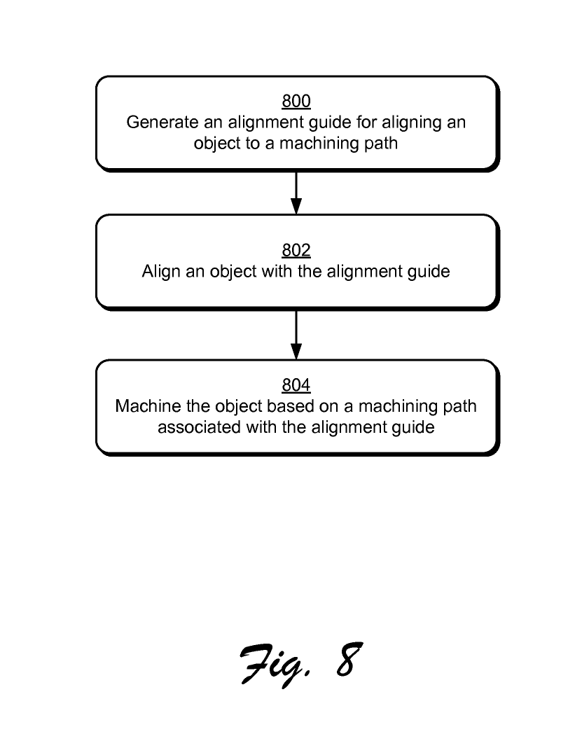

FIG. 8 is a flow diagram that describes steps in a method in accordance with one or more embodiments. Step 800 generates an alignment guide for aligning an object to a machining path. For instance, the alignment guide can be a data representation of a particular region in a 3-dimensional coordinate space, such as defined by X, Y, and Z coordinates. In at least some implementations, the alignment guide can be generated based on a correspondence between a design profile and/or pattern to be machined into an object, and a particular machining tool to be used to perform the machining.

Step 802 aligns an object with the alignment guide. The object, for example, can be manipulated via translation and/or rotation such that the object aligns with the alignment guide. As referenced above, alignment with the alignment guide can cause at least a portion of the object (e.g., a corner and/or edge) to overlap with a coordinate region defined by the alignment guide.

Step 804 machines the object based on a machining path associated with the alignment guide. As discussed above, the machining can cause portions of the object (e.g., corners) to be conformed to a particular profile and/or pattern.

Example System and Device

FIG. 9 illustrates an example system generally at 900 that includes an example computing device 902 that is representative of one or more computing systems and/or devices that may implement the various techniques described herein. The computing device 902 may be, for example, be configured to assume a variety of different configurations, such as a desktop device, a mobile device, an industrial production device, and so on, although other examples are also contemplated.

The example computing device 902 as illustrated includes a processing system 904, one or more computer-readable media 906, and one or more I/O interface 908 that are communicatively coupled, one to another. Although not shown, the computing device 902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that may be configured as processors, functional blocks, and so forth. This may include implementation in hardware as an application specific integrated circuit or other logic device formed using one or more semiconductors. The hardware elements 910 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 906 is illustrated as including memory/storage 912. The memory/storage 912 represents memory/storage capacity associated with one or more computer-readable media. The memory/storage component 912 may include volatile media (such as random access memory (RAM)) and/or nonvolatile media (such as read only memory (ROM), Flash memory, optical disks, magnetic disks, and so forth). The memory/storage component 912 may include fixed media (e.g., RAM, ROM, a fixed hard drive, and so on) as well as removable media (e.g., Flash memory, a removable hard drive, an optical disc, and so forth). The computer-readable media 906 may be configured in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 may be configured in a variety of ways to support user interaction.

The computing device 902 is further illustrated as being communicatively and physically coupled to an input device 914 that is physically and communicatively removable from the computing device 902. In this way, a variety of different input devices may be coupled to the computing device 902 having a wide variety of configurations to support a wide variety of functionality. In this example, the input device 914 includes one or more keys 916, which may be configured as pressure sensitive keys, mechanically switched keys, and so forth.

The input device 914 is further illustrated as include one or more modules 918 that may be configured to support a variety of functionality. The one or more modules 918, for instance, may be configured to process analog and/or digital signals received from the keys 916 to determine whether a keystroke was intended, determine whether an input is indicative of resting pressure, support authentication of the input device 914 for operation with the computing device 902, and so on.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 902. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Thus, computer-readable storage media does not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 902, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of a module that is executable by the computing device 902 as software may be achieved at least partially in hardware, e.g., through use of computer-readable storage media and/or hardware elements 910 of the processing system 904. The instructions and/or functions may be executable/operable by one or more articles of manufacture (for example, one or more computing devices 902 and/or processing systems 904) to implement techniques, modules, and examples described herein.

A number of methods are discussed herein that may be implemented to perform techniques discussed herein. Aspects of the methods may be implemented in hardware, firmware, or software, or a combination thereof. The methods are shown as a set of blocks that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100 and/or the example implementation scenarios discussed above.

Conclusion

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. An apparatus comprising:
a sensing device configured to measure one or more dimensions of an object; and
at least one module configured to receive the one or more dimensions from the sensing device, generate an object profile for the object based on the dimensions, and adjust a machining path to generate an adjusted machining path usable to machine the object based on the object profile.

2. An apparatus as described in claim 1, wherein the sensing device comprises one or more contact probes configured to contact a surface of the object to enable the one or more dimensions to be measured.

3. An apparatus as described in claim 1, wherein the sensing device comprises one or more lasers configured to scan a surface of the object to enable the one or more dimensions to be measured.

4. An apparatus as described in claim 1, wherein the object profile comprises data points that indicate a relative position of a peripheral surface of the object in a coordinate space.

5. An apparatus as described in claim 1, wherein the at least one module is configured to control a machining tool to cause machining of the object based on the adjusted machining path.

6. An apparatus as described in claim 5, wherein the machining of the object causes a specified pattern to be machined into a peripheral edge of the object.

7. An apparatus as described in claim 1, further comprising a machining device operable to machine the object based on the adjusted machining path.

8. A computer-implemented method comprising:
detecting one or more attributes of an object, the one or more attributes including one or more dimensions of the object;
generating an object profile based on the attributes; and
determining a machining path usable to machine the object based on the object profile.

9. A computer-implemented method as described in claim 8, wherein said detecting comprises controlling a sensing device to detect the one or more attributes.

10. A computer-implemented method as described in claim 8, wherein said generating comprises connecting data points that describe relative positions of points on a surface of the object to generate the object profile.

11. A computer-implemented method as described in claim 8, wherein said determining comprises adjusting a predetermined machining pattern based on the object profile to determine the machining path.

12. A computer-implemented method as described in claim 11, wherein said adjusting comprises at least one of adjusting the predetermined machining path dimensionally or adjusting the predetermined machining path positionally.

13. A computer-implemented method as described in claim 8, further comprising causing the object to be machined based on the machining path to apply a pre-specified edge pattern to one or more peripheral edges of the object.

14. A computer-implemented method as described in claim 8, wherein the object comprises a chassis for a portable computing device, and wherein the method further comprises causing the chassis to be machined based on the machining path to apply a pre-specified edge pattern to one or more peripheral edges of the chassis.

15. A computer-implemented method as described in claim 8, further comprising:
causing the object to be machined based on the machining path to apply a pre-specified edge pattern to a peripheral edge of the object;
aligning the object with an alignment guide associated with a different machining path; and
causing one or more corners of the peripheral edge to be machined based on the different machining path.

16. A computer-implemented method comprising:
aligning an object with an alignment guide, the alignment guide representing a specified region in a coordinate space and being associated with a machining path for the object; and
causing the object to be machined based on the machining path.

17. A computer-implemented method as described in claim 14, wherein the alignment guide is representative of a curved 2-dimensional plane that has a specific location in a 3-dimensional coordinate space.

18. A computer-implemented method as described in claim 14, wherein said aligning comprises manipulating the object via a computer-controlled device to align with the alignment guide.

19. A computer-implemented method as described in claim 14, wherein said aligning comprises aligning a corner of the object with a curve defined by the alignment guide, and wherein said causing comprises causing the corner of the object to be machined to match a specified corner profile.

20. A computer-implemented method as described in claim 14, wherein the object comprises a chassis for a portable computing device, and wherein said causing comprises causing at least a portion of the chassis to be machined based on a specified profile.
